(19) United States
(12) Patent Application Publication
(10) Pub. No.: US 2009/0106139 A1
(43) Pub. Date: Apr. 23, 2009

(54) COST RECOVERY BILLING SYSTEM

(76) Inventor: Terry L. Henley, Troy, OH (US)

Correspondence Address: A PATENT LAWYER CORP, PLC;R WILLIAM GRAHAM, 22 S ST CLAIR ST, DAYTON, OH, 45402, US

(21) Appl. No.: 12/344,202

(22) Filed: Dec. 24, 2008

Related U.S. Application Data
(63) Continuation-in-part of application No. 10/793,206, filed on Mar. 4, 2004.

(51) Int. Cl. G06Q 40/00

(52) U.S. Cl. 705/35

(57) ABSTRACT

A cost recovery billing system for a responder department includes a first computer based device having cost recovery billing software operably disposed thereon for purposes of billing a responsible party for an at fault incident. The system electronically receives responsible party incident report data from a responder, searches the responsible party incident report data for cost determinative data, manipulates the cost determinative data to provide cost data and associating the cost data with insurance claim data in order to produce bill data for presentation to an insurance provider.

### BACKGROUND OF THE INVENTION

1. Field of the Invention

The present invention relates to the recovery of costs associated with responding to emergency situations. More particularly, the present invention relates to a cost recovery billing system for costs associated with responding to an emergency.

2. Background of the Invention

Responders (which include, officers, fire department personnel and other emergency attendants, as referred to herein for example) are burdened by significant un-recouped expense in responding to an “at-fault” incident where there is commonly one or more responsible party. “At-fault incident” as used herein means an event, such as false alarm or accident, wherein responders are dispatched out to a site wherein a living party (i.e., responsible party) has triggered the event which has precipitated the need for the responder to appear at such site and render service thereat. The responsible party typically does not pay for the responder's services.

Additionally, many homes and businesses have alarm systems. These residential and business alarm systems lead to unnecessary emergency calls as false alarm dispatches for emergency vehicles. In some communities, dispatches have tripled. Inexperience with these systems has driven false alarm dispatches to nuisance levels and increased emergency departmental costs. In addition, the safety of the citizens and responders are placed at a higher traffic risk.

Alarm companies collect a monthly fee for monitoring security systems electronically and initiating the dispatch of responders to the residence or business location. These alarm companies are in essence marketing the responder's services without reimbursing the responder. Thus, false alarms and at-fault accidents place an unnecessary expense on the responder's department. Accordingly, there is a need for providing a system which enables recovery for such at-fault incidents. There is need to reduce or deter false alarms. There is also a need to better handle at-fault incidents. The present invention offers a cost recovery billing system which solves or at least reduces the impact of the above-identified problems and other problems associated with responding to false alarms and at-fault accidents.

### SUMMARY OF THE INVENTION

An object of the present invention is to aid in recovering responder department's costs associated with at-fault incidents.

Another object of the present invention is to reduce or deter false alarms.

Another object is to provide a system for quickly assessing incidents.

Still another object is to provide a system for assessing and billing at-fault incidents.

Another object of the invention is to provide for a cost recovery billing system which places responder department costs on the responsible party.

It is an object to reduce police and fire department costs.

An additional object of the present invention is to provide a cost recovery billing system which will reduce the amount of administrative collection work for police and fire departments.

Another object of the present invention is to provide a cost recovery billing system which solves or at least reduces the impact of the above-identified problems and other problems associated with responding to false alarms and at-fault accidents.

Accordingly, one embodiment of the present invention is directed to a cost recovery billing system for a responder department, which includes a first computer based device having cost recovery billing software operably disposed thereon for purposes of billing a responsible party for an at-fault incident. The software is equipped for electronically receiving responsible party incident report data from a responder and for searching the responsible party incident report data for cost determinative data. Further, the software is equipped for manipulating the cost determinative data to provide cost data and associating the cost data with insurance claim data in order to produce bill data for presentation to an insurance provider. An accessible database memory storage device is provided for storing the insurance claim data therein upon receiving responsible party incident report data from the responder, wherein the first computer based device can obtain the insurance claim data therefrom.

Cost recovery billing software can also preferably be operably associated with a telephone or credit merchant service provider database, for example, wherein the service provider database includes a contact data listing which can include telephone number(s) having associated street addresses and associated names. The service provider can be a telephone company, an alarm monitoring company or a credit card company with whom the responsible party has an established account.

Preferably, when a party calls for a responder, the cost recovery billing software receives contact data of the responsible party. The cost recovery billing software automatically compares the provided contact data with the contact data listing in one or more service provider databases and verifies the responsible party contact data for purposes of billing.

Upon verifying the provided contact data, the cost recovery billing software assigns a responder charge to be made by the responsible party which can be to an insurance company or direct to the party or indirect through one of the service providers. In the case of receiving the responsible party incident report data and insurance claim data, the insurance company can be billed. In the case, where no insurance claim data exists, the contact data can be verified and the responsible party can be billed through the party's established service provider (e.g., telephone company, alarm company or credit card company) account.

These and various other advantages and features of novelty which characterize the invention are pointed out with particularity in the claims annexed hereto and forming a part hereof. However, for a better understanding of the invention, its advantages and objects attained by its use, reference should be had to the drawings which form a further part hereof, and to the accompanying descriptive matter, in which there is illustrated and described a preferred embodiment of the invention.

### BRIEF DESCRIPTION OF THE DRAWINGS

FIG. 1 is a block diagram of an embodiment of the present invention.

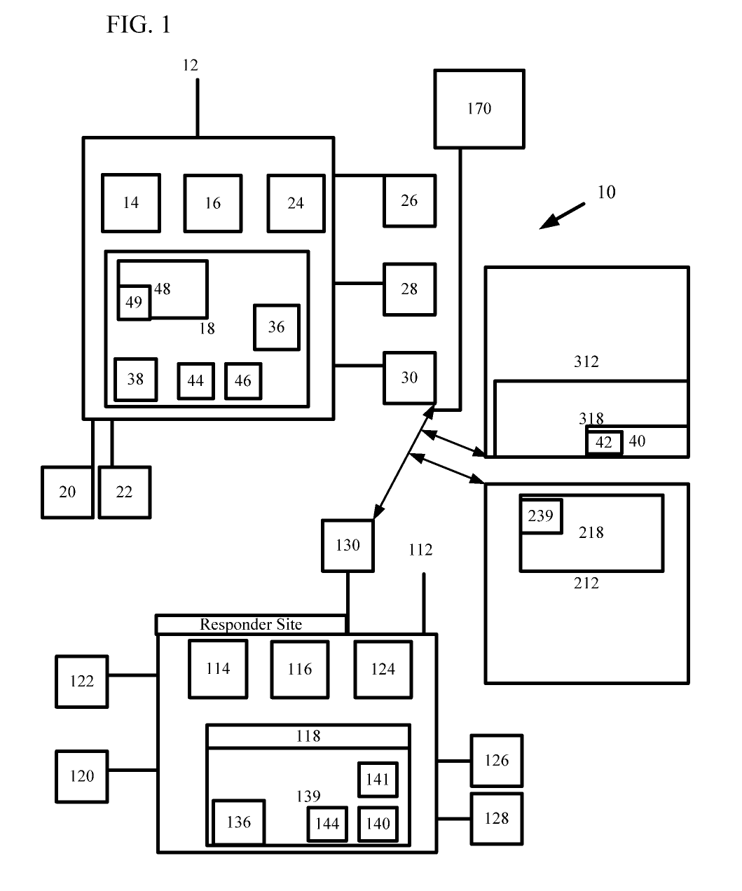

### DETAILED DESCRIPTION

Referring now to the drawing, the cost recovery billing system is generally referred to by the numeral 10. The system 10 includes at least one computer 12 and which can include and is capable of running standard operating system software such as Windows, Linux, or Unix.

The computer 12 can preferably have a central processor (CPU) 14, random memory 16, permanent memory 18 (e.g., hard or fixed disk, optical disk, magneto-optical disk, or flash memory), and can include a keyboard 20, a mouse 22 (or like pointing device), a clock 24 and a display or screen device 26, otherwise known in the art to lend functionality to the computer 12. Processor 14 is operably associated with memory 16 for storing frequently accessed information. One or more input/output device(s) 28, such as a printer can be included. The computer 12 can preferably include a communication link 30 which can be a LAN, WAN, modem connection or other communication line, for example. Operably residing on the computer 12 is operating system software 36 and can be, for example, of a type described above or is known in the art. The operating software 36 is preferably stored in memory 18, and can include a one or more application programs as is known in the art.

Preferably, another computer 112 can be provided which has a central processor (CPU) 114, random memory 116, permanent memory 118, and can include a keyboard 120, a mouse 122, a clock 124 and a display or screen device 126, input/output device(s) 128, and a communication link 130, for example. Residing on the computer 112 is operating software 136 and includes a one or more applications as above. It should be noted that the invention can be modified, e.g., to add or delete devices, such as device 28, so long as the ability to perform the intended objectives of the invention can be carried out. While shown here on computer 12 at a remote site, it is understood that the cost recovery billing software 38 can be on a remotely located computer and work in cooperation with conventional browser software.

The computer 12 can be located at a remote site, which can be preferably be off-site accessible through the Internet from the responder's site where computer 112 is located. The computer 112 can be located at the responder site, e.g., at a police or fire department. It is contemplated that the computer 112 can be a hand held device wherein the responder can enter the information for purposes of generating the responsible party incident report data 139 therein and it is automatically rendered to computer 12 and/or 212.

A memory storage device 218 can be operably connected to computer 212 which can be similarly communicatively connected to computers 12 and 112 via the Internet, for example. While not specified, computer 212 can be similarly equipped central processor (CPU), random memory, permanent memory, a keyboard, a mouse, a clock and a display or screen device, input/output device(s), and a communication link. The computer 212 can be situated at or operably disposed for use by an insurance company. In this way, the insurance company can preferably automatically receive responsible party incident report data 139 through the system 10 whereupon receipt of responsible party incident report data 139, insurance claim data 239 is generated and accessibly stored on memory 218 in a manner to permit access thereof of by cost recovery billing software 38.

Cost recovery billing software 38 is shown here on a memory 18 and can be operably associated with a service provider database 40 which can be stored on memory 318 and operably connected to computer 312. Computer 312 can be similarly communicatively connected to computers 12, 112 and 212 via the Internet, for example. While not specified, computer 312 can be similarly equipped central processor (CPU), random memory, permanent memory, a keyboard, a mouse, a clock and a display or screen device, input/output device(s), and a communication link. The computer 312 can be situated at or operably disposed for use by a service provider company, such as a telephone service provider, for example. The service provider database 40 includes a contact data listing 42 of telephone numbers each having associated street addresses and associated names.

Responsible party incident report data 139 can be operably input into computer 112. The cost recovery billing software 38 can preferably be capable of automatically receiving responsible party incident report data 139 and contact data 140 therein which is shown here, by way of example, on computer 112. The cost recovery billing software 38 is equipped to compare the provided contact data 140 with the contact data listing 42 of telephone numbers, addresses and names in service provider database 40. If no contact data is relevant for such comparison, the system 10 can prepare a billing without such comparison by using contact data 140 and insurance claim data 239.

In the case of comparing contact data, the cost recovery billing software 38 can generate and communicate a signal to the computer 112 indicative of verifying the provided contact data 140 is accurate for purposes of billing. This can be helpful to a responder in real time advising the responder in order to confirm current contact data of the responsible party and hence generate an accurate responsible party incident report data 139. It can also be that the cost recovery billing software 38 obtains the contact data 140 automatically, such as automatically retrieving responsible party incident report data 139 from computer 112 (at responder site) as it is created via a live link with browser technology employed on the computer 112 using cost recovery software 38. Toward this end, upon receiving an incoming telephone number of the responsible party through caller id, for example, the cost recovery billing software 38 can perform the comparison and verification through one or more said databases.

The responsible party incident report data 139 can include data contact data 140 and cost determinative data 141. Contact data 140 can include client name field, client name data corresponding thereto, contact name field, contact name data corresponding thereto street address field, street address data corresponding thereto, city address field, city address data corresponding thereto state zip code field, zip code data corresponding thereto country field, country data corresponding thereto work, fax and home telephone fields, and number data corresponding thereto. Cost determinative data 141 can include key data field and key data corresponding thereto. For example, key data can include fatality, major injury, minor injury, no injury, major, minor, or no property damage, number of dispatched and type of responders, time for responder. Cost recovery billing software 38 receives the responsible party incident report data 139 and is equipped for searching the responsible party incident report data 139 for cost determinative data 141. Cost recovery billing software 38 manipulates the cost determinative data 141 by attributing cost amounts to each cost determinative data 141 and summing the amounts to provide cost data and associates the cost data with insurance claim data 239 in order to produce bill data 49 for presentation to an insurance provider.

The following Table 1 is illustrative of the cost determinative data 141.

TABLE 1

| | ON SCENE TIME | | | | |
|---|---|---|---|---|---|
| Key data | 30 min | 45 min | 60 min | 75 min | 90 min |

Fatality

| | | | | | |
|---|---|---|---|---|---|
| No. Vehicles | $154 | $154 | $154 | $154 | $154 |
| No. Officers | $14 | $21 | $28 | $35 | $42 |
| Station Prep/Admin | $108 | $114 | $119 | $124 | $129 |

A-Level

| | | | | | |
|---|---|---|---|---|---|
| No. Vehicles | $154 | $154 | $154 | $154 | $154 |
| No. Officers | $14 | $21 | $28 | $35 | $42 |
| Station Prep/Admin | $91 | $96 | $101 | $106 | $111 |

B-Level

| | | | | | |
|---|---|---|---|---|---|
| No. Vehicles | $154 | $154 | $154 | $154 | $154 |
| No. Officers | $14 | $21 | $28 | $35 | $42 |
| Station Prep/Admin | $76 | $80 | $86 | $91 | $96 |

C-Level

| | | | | | |
|---|---|---|---|---|---|
| No. Vehicles | $154 | $154 | $154 | $154 | $154 |
| No. Officers | $14 | $21 | $28 | $35 | $42 |
| Station Prep/Admin | $76 | $78 | $80 | $82 | $84 |

PDO

| | | | | | |
|---|---|---|---|---|---|
| No. Vehicles | $154 | $154 | $154 | $154 | $154 |
| No. Officers | $14 | $21 | $28 | $35 | $42 |
| Station Prep/Admin | $76 | $78 | $80 | $82 | $84 |

COURT TIME AND WITNESS INTERVIEW @ $80/hr
Fatality: Crash resulting in death of an individual within 30 days of the accident
A-Level: Crash with one incapacitating injury
B-Level: Crash with one person with a visible injury but not incapacitating
C-Level: Crash with one person with a possible injury
PDO: Property Damage Only with a value of $500 on any single vehicle resulting in a claim filed to an insurance company or if cited individual is without insurance. Any response to the scene will receive the minimum 30 minute cost. Costs are additive, if two vehicles respond, the cost is twice what is listed as well as the staff.

Once the cost determinative data 141, contact data 140, insurance claim data 239 (if available) are obtained, the cost recovery billing software 38 manipulates said data in order to assign or assess responder charges into bill data 49 and hence present to the appropriate payor (i.e., responsible party or insurance company). In the case where, a responsible party in contact data listing 42 is on an established account with such a service provider (i.e., telephone company), the cost recovery billing software 38 is equipped to bill the responder charges through such established account.

It is noted that the cost recovery billing software 38 can be operatively residing on either or both of the computers 12 and 112, for example. It is further contemplated that the cost recovery billing software 38 can be web-based and that browser technology can be employed to use the software 38. Thus, the location of the cost recovery billing software 38 can be so situated to carry out the invention.

In a preferred embodiment, the cost recovery billing software 38 can be operably disposed on computer 12 for purposes of billing a responsible party for an at-fault incident. In this regard, the computer 12 is so equipped for electronically receiving responsible party incident report data 139 from a responder via computer 112.

The cost recovery billing software 38 can is also equipped for associating, logging and storing of contact data 140 into a responsible party data file 44 via a responsible party screen which displays responsible party name field, responsible party name field, street address field, city address field, state zip code field, country field, work, fax and home telephone fields and creates a unique identification for each responsible party. The cost recovery billing software 38 provides entry of responder data 144 into a responder data file 46 via a responder provider screen having company name field, responder provider name field, street address field, city address field, state zip code field, country field, work, fax and home telephone fields, predetermined types of charge fields and unique identification for the responder provider is permitted and stored in the responder data file 46. The cost recovery billing software 38 provides for associating and accruing charges of the responder's services/goods obtained or used by a responsible party to be billed and writing and storing such all accrued charges into a billing data file 48.

The cost recovery billing software 38 can be automatically initiated electronically by identifying a responsible party's telephone number (in contact data 140) and compare this number to contact data listing 42 in service provider's database 40 (e.g., a telephone company's database having the responsible party as a client). Optionally, the cost recovery billing software 38 displays a screen (e.g., a windows-based screen) on the monitor 126 prompting the responder to enter the responsible party contact data 140. The responder can cancel the operation for no-fault incident. The cost recovery billing software 38 provides for the screen to minimize or for exiting of the cost recovery billing software 38 upon cancellation of operation. Upon logging the responsible party contact data 140, cost recovery billing software 38 performs a verification of the contact data 140 by comparing against the contact data listing 42 and displays a screen verifying the responsible party contact data 140. If verified, the cost recovery billing software 38 enables responder service charges to be accrued through to the responsible party billing data file 48.

If not confirmed, cost recovery billing software 38 generates a call signal to responder and/or to an alternative billing mechanism 170 (such as a billing call center), wherein the alternative billing center 170 is equipped to handle credit card billing or other suitable billing arrangement between the responsible party and the responder.

The cost recovery billing software 38 is preferably continuously running to receive contact data 140 and assign charges to the responsible party billing data file 44 and in turn, the cost recovery billing software 38 enables the generation of an invoice (by way of any suitable printing means) to the client on behalf of the responder. Herein, the invoice generated would include listing the responsible party data and responder data with itemized services/goods provided.

By so providing the instant invention as described herein, a recovery of cost associated with at-fault incident can be achieved and safety maximized. The invention can also progressively monitor those who habitually send the fire and police departments to such sites. The invention can receive contact data of the responsible party and directly bill the party's insurance company, place the resultant charge for the dispatched personnel on the responsible party's telephone bill, for example, for payment through the party's telephone company or other engaged responsible party/service provider account or bill the party directly. The invention can be programmatically set to maintain the status of every dispatch and systematically bills the responsible party based on predetermined criteria, such as a determination that the dispatch was an at-fault type incident or such other criteria established by the governing regulations of the party's domicile or place of business.

The invention protects taxpayer investment by recovering alternative funds from the responsible party. Alarm dispatches will likely decline in number by holding habitual violators responsible through a user fee program provided by the invention. Responder personnel and citizens are at reduced traffic risk by avoiding unnecessary dispatches. Citizens can receive expected response on real emergencies by reducing the number of responders that are dispatched because of false alarms.

The contact data, and cost determinative data, and insurance claim data needed to bill the at-fault incidents can preferably be routed electronically through the system 10. Responder departments are operably associated with the billing cost recovery system 10 of the instant invention to communicate an electronic record of the at-fault incident from the responder department in order that the charges can be recouped.

The above described embodiment is set forth by way of example and is not for the purpose of limiting the present invention. It will be readily apparent to those skilled in the art that obvious modifications, derivations and variations can be made to the embodiment without departing from the scope of the invention. Accordingly, the claims appended hereto should be read in their full scope including any such modifications, derivations and variations.

What is claimed is:

1. A cost recovery billing system for a responder department, which includes:
a first computer based device having cost recovery billing software operably disposed thereon for purposes of billing a responsible party for an at fault incident, means for electronically receiving responsible party incident report data from a responder, said cost recovery billing software including means for searching said responsible party incident report data for cost determinative data, manipulating said cost determinative data to provide cost data and associating said cost data with insurance claim data in order to produce bill data for presentation to an insurance provider.

2. The cost recovery billing system of claim 1, which further includes an accessible database memory storage device for storing said insurance claim data therein upon receiving responsible party incident report data from said responder, and said first computer based device can obtain said insurance claim data therefrom.

3. The cost recovery billing system of claim 1, wherein said accessible database memory storage device is operably connected to said first computer based device.

4. The cost recovery billing system of claim 1, wherein said accessible database memory storage device is operably connected to a second computer based device which performs said storing of said insurance claim data.

5. The cost recovery billing system of claim 1, which further includes an accessible service provider database which includes a contact data listing for a plurality of parties, and wherein said cost recovery billing software is equipped to compare and verify contact data from said responsible party incident report data with said contact data in said service provider database for purposes of producing said bill.

6. The cost recovery billing system of claim 5, wherein said contact data listing includes a telephone number having an associated street address and associated name for each said contact therein.

7. The cost recovery billing system of claim 1, wherein said cost recovery billing software includes means for automatically receiving responsible party incident report data.

8. The cost recovery billing system of claim 1, wherein said cost recovery billing software includes means for automatically receiving said insurance claim data.

9. A method of billing a party through a cost recovery billing system for a responder department, which includes the steps of:
generating a responsible party incident report data through a responder, said responsible party incident report data having contact data therein; and
employing a first computer based device having cost recovery billing software operably disposed thereon for purposes of billing a responsible party for an at fault incident, means for electronically receiving said responsible party incident report data from said responder, said cost recovery billing software including means for searching said responsible party incident report data for cost determinative data, manipulating said cost determinative data to provide cost data and associating said cost data with insurance claim data in order to produce bill data for presentation to an insurance provider.

10. The method of claim 9, which further includes employing an accessible database memory storage device for storing said insurance claim data therein upon receiving responsible party incident report data from said responder and wherein said first computer based device can obtain said insurance claim data therefrom.

11. The method of claim 9, wherein said accessible database memory storage device is operably connected to said first computer based device.

12. The method of claim 9, wherein said accessible database memory storage device is operably connected to a second computer based device which performs said storing of said insurance claim data.

13. The method of claim 9, which further includes employing an accessible service provider database which includes a contact data listing for a plurality of parties, and wherein said cost recovery billing software is equipped to compare and verify contact data from said responsible party incident report data with said contact data in said service provider database for purposes of producing said bill.

14. The method of claim 10, wherein said contact data listing includes a telephone number having an associated street address and associated name for each said contact therein.

15. The cost recovery billing system of claim 9, wherein said cost recovery billing software includes means for automatically receiving responsible party incident report data.

16. The method of claim 9, wherein said responder is one of a fire department entity, police department entity, and emergency health department entity.

17. The method of claim 13, wherein said service database provider includes one of a telephone company database, an alarm monitoring company database, a credit card company database, insurance database and a responder company database.

18. The method of claim 15, which further includes the step of automatically obtaining said contact data from said party incident report data using said cost recovery billing software which includes at least one of data field search and key word search.
